(19) United States
(12) Patent Application Publication
(10) Pub. No.: US 2017/0318220 A1
(43) Pub. Date: Nov. 2, 2017

(54) IMAGING A ROTATING COMPONENT

(71) Applicant: ROLLS-ROYCE PLC, London (GB)

(72) Inventor: David MILLER, Derby (GB)

(73) Assignee: ROLLS-ROYCE PLC, London (GB)

(21) Appl. No.: 15/485,611

(22) Filed: Apr. 12, 2017

(30) Foreign Application Priority Data
Apr. 29, 2016 (GB) 1607456.9

(51) Int. Cl. H04N 5/232; B63H 5/07; G03B 15/00; G02B 26/08; G03B 17/08; B64D 27/16; B64D 33/02; F04D 15/00; B64D 47/08; B64D 45/00; H04N 7/18; B64D 27/10; F02K 3/06

(52) U.S. Cl. CPC H04N 5/23238; H04N 7/183; B63H 5/07; G03B 15/006; G02B 26/0825; G03B 17/08; B64D 27/10; B64D 27/16; B64D 33/02; F04D 15/0088; B64D 47/08; B64D 45/00; F02K 3/06; B64D 2045/0085; F05D 2220/323; F05D 2260/83

(57) ABSTRACT

An imaging apparatus for imaging a rotating component is shown. The imaging apparatus has a proximal end configured to be attached to the rotating component, along with a distal end. The imaging apparatus has located within it a convex mirror at the distal end, which has a reflective surface which is directed toward the proximal end and having a field of view wider than the imaging apparatus. The imaging apparatus also has located within it a camera at the proximal end, the camera being directed towards to distal end and having a field of view which includes the mirror.

### TECHNICAL FIELD

The present invention relates to an imaging apparatus for imaging a rotating component.

### BACKGROUND OF THE INVENTION

It is often desirable under test and/or service conditions to image a rotating component, such as the blades of a fan in a turbofan engine, or the blades of a marine propeller.

A known approach involves providing multiple cameras which are mounted upon and rotate with a helicopter rotor—typically one per blade. However, this approach is not suitable for components that rotate at higher speed due to the attendant increase rotational forces, and in any event is highly sensitive to any out-of-balance condition of the imaging system.

Strobe cameras which remain static with respect to the component may also be used, but it is difficult to synchronize the strobe rate with the rotation rate of the component, particular during accelerations thereof.

### SUMMARY OF THE INVENTION

The present invention is therefore directed towards an imaging apparatus for imaging a rotating component. The imaging apparatus has a proximal end configured to be attached to the rotating component, along with a distal end. The imaging apparatus has located within it a convex mirror at the distal end, which has a reflective surface which is directed toward the proximal end and having a field of view wider than the imaging apparatus. The imaging apparatus also has located within it a camera at the proximal end, the camera being directed towards to distal end and having a field of view which includes the mirror.

### BRIEF DESCRIPTION OF THE DRAWINGS

The invention will now be described by way of example only with reference to the accompanying drawings, which are purely schematic and not to scale, and in which:

FIG. 1 shows a sectional side view of a turbofan engine;

FIG. 2 shows a plan view of the fan of the engine of FIG. 1;

FIG. 3 shows the nose cone of the fan of FIG. 2;

FIG. 4 shows components within the camera of the nose cone of FIG. 3.

### DETAILED DESCRIPTION OF THE INVENTION

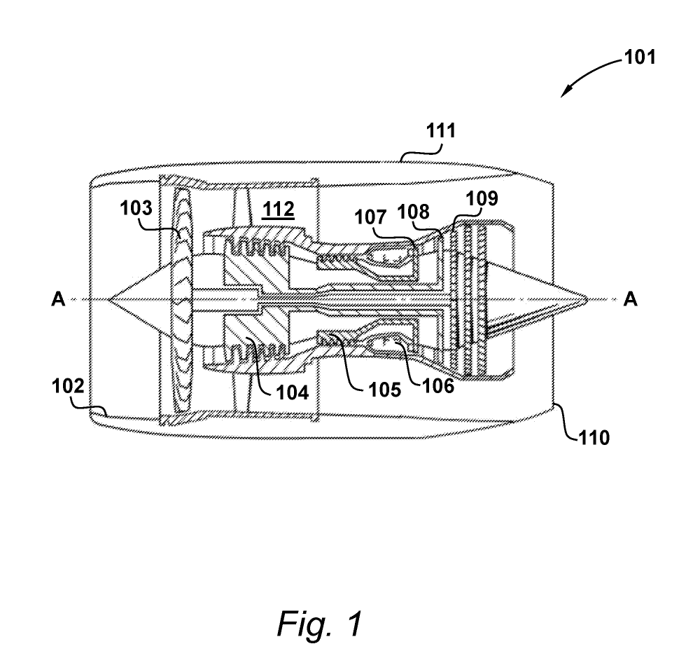

### FIG. 1

A turbofan engine 101 for an aircraft is shown in FIG. 1, components of which may be imaged using an imaging apparatus according to an aspect of the present invention.

The engine 101 has a principal and rotational axis A-A and comprises, in axial flow series, an air intake 102, a propulsive fan 103, an intermediate pressure compressor 104, a high-pressure compressor 105, combustion equipment 106, a high-pressure turbine 107, an intermediate pressure turbine 108, a low-pressure turbine 109, and an exhaust nozzle 110. A nacelle 111 generally surrounds the engine 101 and defines both the intake 102 and the exhaust nozzle 110.

The engine 101 works in the conventional manner so that air entering the intake 102 is accelerated by the fan 103 to produce two air flows: a first air flow into the intermediate pressure compressor 104 and a second air flow which passes through a bypass duct 112 to provide propulsive thrust. The intermediate pressure compressor 104 compresses the air flow directed into it before delivering that air to the high pressure compressor 105 where further compression takes place.

The compressed air exhausted from the high-pressure compressor 105 is directed into the combustion equipment 106 where it is mixed with fuel and the mixture com busted. The resultant hot combustion products then expand through, and thereby drive the high pressure turbine 107, intermediate pressure turbine 108, and low pressure turbine 109 before being exhausted through the nozzle 110 to provide additional propulsive thrust. The high pressure turbine 107, intermediate pressure turbine 108, and low pressure turbine 109 drive respectively the high pressure compressor 105, intermediate pressure compressor 104, and fan 103, each by a suitable interconnecting shaft.

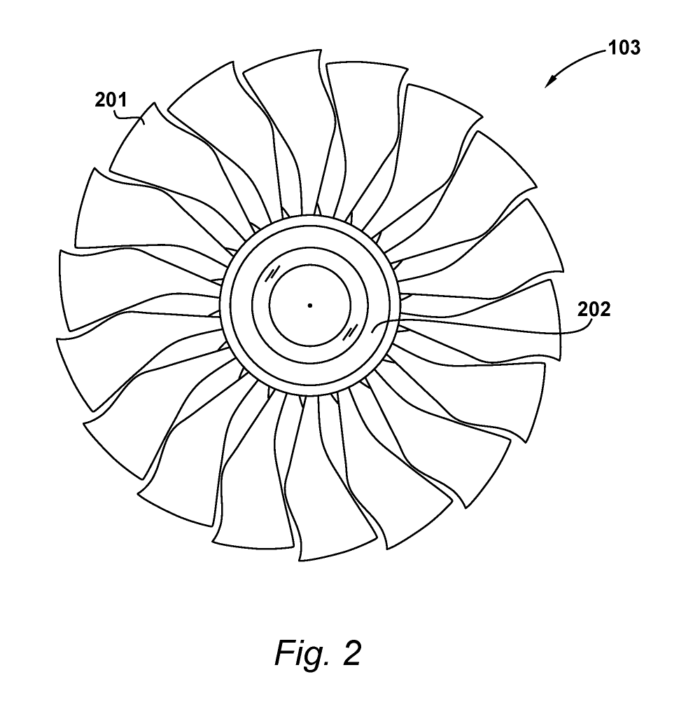

### FIG. 2

The fan 103 of engine 101 is shown in plan view in FIG. 2.

It is particularly important to ensure that the blades 201 of the fan 103 are optimized both aerodynamically and mechanically. This involves performing various testing procedures to validate the design of the fan. For example, it may be necessary to determine whether the blades 201 of the fan 103 vibrate, and if so, the effect of the vibration of a particular blade on those adjacent to it. Further, it may be necessary to perform icing tests in which accretion of ice on the fan blades is forced to occur, which process needs to be analyzed. In a further example, bird-strike tests may need to be performed and thus a determination made as to the resistance of the fan 103 to failure.

It may also be desirable to perform monitoring of the fan 103 during normal operation of the engine 101 as part of an ongoing engine performance and health monitoring strategy.

Thus in the present example, the fan 103 includes an imaging apparatus for imaging the fan 103 (a rotatable component) as it rotates. In this example, the imaging apparatus takes the form of a nose cone 202, which is configured in accordance with an aspect of the present invention. The nose cone 202 is releasably attached to the fan 103 in the known manner, i.e. to the disk or central portion of the blisk depending upon the configuration of the fan.

In use, as the fan 103 rotates, driven by the low pressure turbine 109, so too does the nose cone 202, as it is fixed thereto.

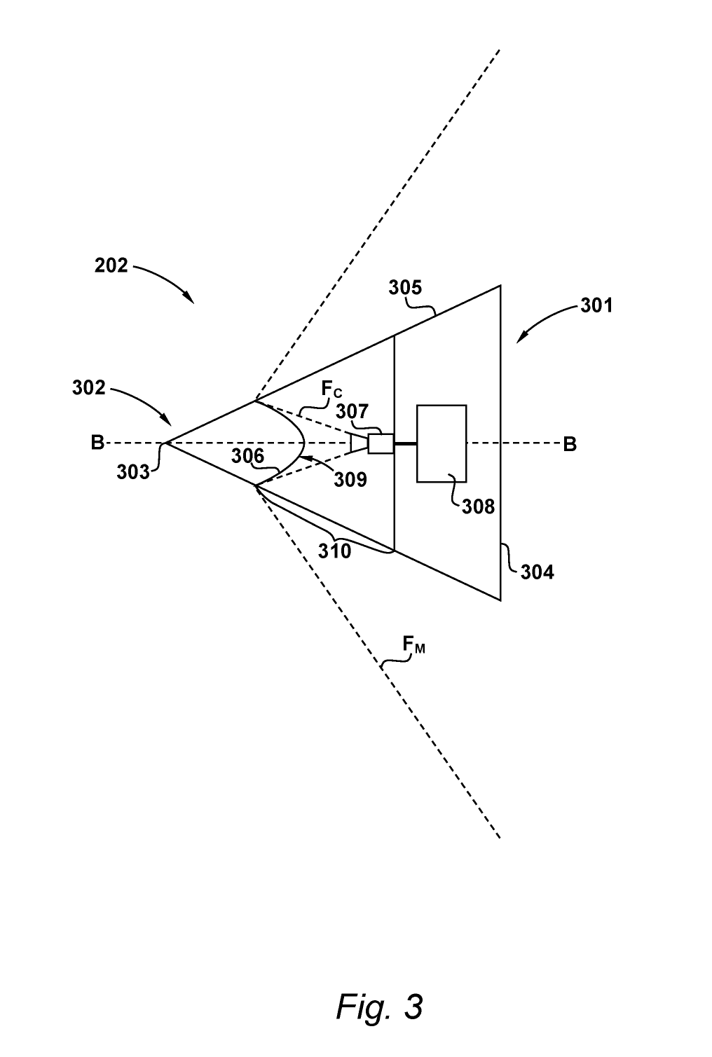

### FIG. 3

A schematic view of nose cone 202 is shown in FIG. 3.

The nose cone 202 has an axis B-B and has a proximal end 301 and a distal end 302. The proximal end 301 is configured to be attached to the fan 103 utilizing standard fixings (not shown) of the known type. In practice, the fixings will align the nose cone 202 such that its axis B-B is coincident with the principal rotational axis A-A of the engine 101.

In this example, the nose cone 202 is generally conical in shape, and thus the distal end 302 forms an apex 303, which tapers to a base radius 304. An outer wall 305 connects the two ends 301 and 302, i.e. the apex to the base radius in the present example.

Imaging is achieved by a combination of a convex mirror 306 located towards the distal end 302 (i.e. at the apex end of the nose cone 202), and a camera 307 located towards the proximal end 303 (i.e. at the base end of the nose cone 202). A power supply in the form of a battery pack 308 is also provided towards the proximal end 301 of the nose cone 202 and is connected with the camera 307 to provide power thereto.

The mirror 306 has a reflective surface 308 which is directed towards the proximal end 301 of the nose cone 202. In the present example, the mirror 306 is located on and is axisymmetric around the axis B-B of the nose cone 202. In alternative embodiments, however, the mirror 306 may be located off-axis, and/or may be asymmetric. In this case, rotational balance may be restored with appropriate balance weights or equivalent measures, for example. The reflective surface 308 of the mirror 306 is parabolic in the present embodiment so that rays are brought into focus at the same point. In alternative embodiments, a spherical reflective surface could be used, or any other convex shape.

The camera 307 is directed towards the distal end 302 of the nose cone 202. In this way, the camera 307 images the light reflected by the reflective surface 309 of the mirror 306. Again, in this example, the camera is located on the axis B-B of the nose cone 202. However, as with the mirror 306, the camera 307 may be located off-axis with measures taken to ensure balance of the nose cone 202 is acceptable. Thus, the mirror and the camera may both be on-axis, the mirror may be off-axis and the camera on-axis, the mirror may be on-axis and the camera off-axis, or the mirror and the camera may both be off-axis.

In order to achieve imaging of the rotating component, i.e. the fan 103, the mirror 306 has a field of view F_{M} which is wider than the nose cone 202. It should be emphasized that the Figure is not to scale, and the field of view F_{M} may be wider or narrower than that illustrated.

To allow light to reach the reflective surface 309 of the mirror 306, in this example the outer wall 305 of the nose cone 202 has a transparent portion 310. Thus at least a portion of the outer wall 305 is transparent to allow light to enter the imaging apparatus and to thereby reflect from the mirror into the camera. In the present example, the transparent portion 310 extends around the full lateral surface of the nose cone 202. However, in other embodiments the transparent portion 310 may only extend around a part of the full lateral surface. There may be multiple transparent portions distributed around the full lateral surface.

Furthermore, in the present example, the transparent portion 310 is a transparent acrylic, but other materials may of course be substituted as appropriate, possibly with a glass, for example. In an alternative embodiment, it is envisaged that the whole outer wall 305 may be transparent rather than just the transparent portion 310.

As described previously, the camera 307 images the light reflected by the reflective surface 308 of the mirror 306. The camera 307 has a field of view F_{C} which includes the mirror 306. In the present example, the field of view F_{C} is centered on the mirror.

Again, however, the field of view F_{C} may differ from that illustrated in the Figure. Indeed, in alternative embodiments, the field of view F_{C} may be variable by the provision of a zoom lens in the camera. It may also be off-center with respect to the mirror. So long as the field of view F_{C} includes at least part of the mirror, which has a field of view F_{M} which includes at least part of the rotating component, imaging as contemplated by the present invention may be achieved.

It will be appreciated by those skilled in the art that the field of view F_{M} of the mirror is dependent on its focal length. Thus, in an embodiment, the mirror 306 has a variable focal length. To achieve this, the mirror may be configured to be deformable such that the geometry of the reflective surface 309 results in a change in focal length. Appropriate re-focusing of the camera 307 may then be performed.

Additionally, or separately, the camera 307 may be a light-field camera. In such a case, focusing need not take place as both intensity and direction of the light rays entering the camera lens are recorded. As an example, the light-field camera may be a plenoptic-type camera.

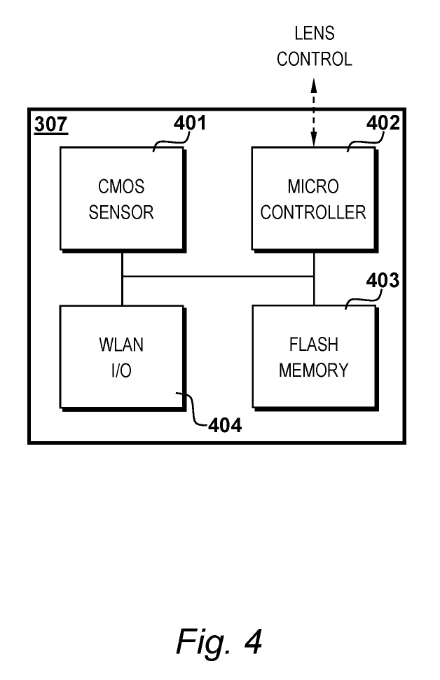

### FIG. 4

A schematic of the components within camera 307 is shown in FIG. 4. The lens is omitted for clarity, but it will be appreciated by those skilled in the art that the lens will be a typical camera lens appropriate for focusing light reflected by mirror 306. It will be appreciated that the camera 307 is generally of standard form.

In the present example, the camera 307 is a digital camera and therefore includes an electronic image sensor, which in the present example is a CMOS sensor 401. The sensor 401 operates under the control and supplies output data to a processing device, which in this example is a microcontroller 402. The microcontroller 402 also includes a degree of built-in memory in the form of ROM which stores appropriate program instructions for camera operation and image processing, etc. The microcontroller 402 is also connected with the lens (not shown) of the camera to perform focusing in the present example.

In the present example, the camera 307 is configured to, by means of sensor 401 and microcontroller 402, produce individual still images and/or video in digital format. Thus in operation, the sensor 401 converts light into electrical signals which are digitized, processed and encoded to an appropriate data file format by the microcontroller 402. In a specific embodiment, the microcontroller 402 performs a correction procedure on the images and/or video. As the geometry and distortion caused by the mirror 306 is a deterministic process, appropriate characterization may be carried out and, for example, a transformation matrix defined and applied to the captured images and/or video to correct said distortion.

The still images and/or video may then be stored for later retrieval to non-volatile memory in the form of a Flash memory device 403. In addition, or alternatively, the still images and/or video may be transmitted to a receiving station by a data transmission device, such as a wireless local area network (WLAN) interface 404. In the present example, the WLAN interface 404 may transmit the digital still images or digital video to a receiving device on the same wireless LAN. For example, if the engine 101 were being tested on a test bed, the digital still images or digital video may be transmitted to a nearby receiver for analysis along with any other parameters being monitored. In a further example, the engine 101 may be being tested during flight, with a receiver being provided on the aircraft for in-flight analysis.

In use, the nose cone 202 is attached to the fan 103 and rotates therewith. In this way, the fan 103 appears static in the images produced by the camera 307—the nacelle 111 and the rest of the outside environment would appear to rotate. In this way, the images may be used to analyze deflections in the blades of the fan 103 caused by vibration, loading, or impact. Given the field of view F_{M} may encompass the entirety of the fan 103, the images may be particularly helpful in identifying whole-fan events, or the effect of an event (such as a vibration) in one blade on another blade for example.

It will be appreciated by those skilled in the art that whilst the imaging apparatus shown in the example of FIG. 3 is a nose cone for a fan of a turbofan aircraft engine, the present invention extends to other applications. In particular, it is envisaged that the nose cone 202 according to the present invention may be employed for imaging a propeller (i.e. a type of fan) attached to, for example, a turboprop aircraft engine.

Further, an imaging apparatus according to the present invention may be used for imaging a propeller of a marine vessel. It is envisaged that an imaging apparatus of this type would take the form of a boss (or hub) cap for the propeller of the vessel. In this way cavitation may be imaged, for example. Such a boss cap could be conical as with nose cone 202, or alternatively may adopt a different configuration, such as hemispherical, cylindrical or indeed any other configuration in which a convex mirror may be located at a distal end of the boss cap and a camera located at a proximal end of the boss cap.

In sum, therefore, it will be understood that the invention is not limited to the embodiments described herein, and so various modifications and improvements can be made without departing from the concepts described. Except where mutually exclusive, any of the features may be employed separately or in combination with any other features and the invention extends to and includes all combinations and sub-combinations of one or more features described herein.

1. Imaging apparatus for imaging a rotating component, the imaging apparatus having a proximal end configured to be attached to the rotating component, and a distal end, and having located therein:
a convex mirror toward the distal end, which has a reflective surface which is directed toward the proximal end and having a field of view wider than the imaging apparatus; and
a camera toward the proximal end, the camera being directed towards to distal end and having a field of view which includes the mirror.

2. The imaging apparatus of claim 1, in which the imaging apparatus has an outer wall at least a portion of which is transparent to allow light to enter the imaging apparatus and to thereby reflect from the mirror into the camera.

3. The imaging apparatus of claim 1, in which the field of view of the camera is centered on the mirror.

4. The imaging apparatus of claim 1, in which the mirror has a variable focal length.

5. The imaging apparatus of claim 1, in which the mirror is deformable to vary its focal length.

6. The imaging apparatus of claim 1, in which the camera is a light field camera.

7. The imaging apparatus of claim 1, in which the camera is configured to produce one or more of:
individual still images;
video.

8. The imaging apparatus of claim 1, in which the camera is a digital camera and comprises one or more of:
a data transmission device to transmit digital still images or video;
a data storage device to store digital still images or digital video.

9. The imaging apparatus of claim 1, wherein:
the imaging apparatus is of generally conical form with an apex that tapers to a base radius;
the mirror is located at an apex end with the reflective surface being directed toward a base end, and wherein the field of view of the mirror is wider than the base radius; and
the camera is located at a base end, and is directed towards the apex end.

10. The imaging apparatus of claim 9, in which the mirror is located on and is axisymmetric around the axis of the nose cone.

11. The imaging apparatus of claim 9, wherein the imaging apparatus is a nose cone for imaging the fan of an aircraft engine.

12. The imaging apparatus of claim 11, in which the aircraft engine is one of:
a turbofan engine;
a turboprop engine.

13. The imaging apparatus of claim 1, wherein the imaging apparatus is a boss cap for imaging the propeller of a marine vessel.

14. An aircraft engine having a fan with the nose cone of claim 10 mounted thereon, wherein the field of view of the mirror includes at least a portion of the fan.

15. A marine vessel having a propeller with the boss cap of claim 13 mounted thereon, wherein the field of view of the mirror includes at least a portion of the propeller.
